(19) United States
(12) Patent Application Publication
(10) Pub. No.: US 2024/0296361 A1
(43) Pub. Date: Sep. 5, 2024

(54) DETECTION OF NOISE AND EAVESDROPPING ATTEMPTS ON A QUANTUM COMMUNICATION NETWORK BY PROBING AUXILIARY DEGREES OF FREEDOM

(71) Applicants: Mellanox Technologies, Ltd., Yokneam (IL); Bar-Ilan University, Ramat Gan (IL)

(72) Inventors: Yuval IDAN, Ramat Gan (IL); Avshalom C. ELITZUR, Ramat Gan (IL); Elad MENTOVICH, Tel Aviv (IL); Tali SEPTON, Haifa (IL); Eliahu COHEN, Ramat Gan (IL); Taylor Lee PATTI, Orange, CA (US); Moshe Oron, Rehovot (IL); Yonatan PIASETZKY, Tel Aviv (IL)

(21) Appl. No.: 18/492,330

(22) Filed: Oct. 23, 2023

(30) Foreign Application Priority Data
Mar. 2, 2023 (IL) 301090

(51) Int. Cl. G06N 10/20

(52) U.S. Cl. CPC G06N 10/20

(57) ABSTRACT

Methods, apparatuses, and computer program products are provided for detecting an eavesdropper or other network disturbance on a quantum communication network, based on measurements performed on auxiliary degrees of freedom. An example method includes receiving a quantum state with transmitted physical observables imparted to the quantum particle/s on a first set of one or more degrees of freedom. The method further includes determining a received physical characteristic, based on the received observables within each of an auxiliary set of one or more quantum degrees of freedom. The method includes accessing data reflecting the transmitted physical condition on the auxiliary set of one or more quantum degrees of freedom and comparing the received physical characteristic of the quantum state with the transmitted physical condition. Finally, the method includes generating a notification of interference along the quantum interconnect link upon detecting a difference between the received observables and the interconnected observables.

### CROSS-REFERENCE TO RELATED APPLICATION

This application claims the benefit of Israeli Patent Application No. 301,090, filed Mar. 2, 2023, the entire contents of which is hereby incorporated by reference in its entirety.

### TECHNOLOGICAL FIELD

Embodiments of the present disclosure relate generally to methods, apparatuses, and computer program products for detecting anomalies and non-idealities on a quantum interconnect link by probing auxiliary degrees of freedom upon receipt of transmitted quantum data.

### BACKGROUND

Quantum communication devices leverage quantum mechanics to communicate data over a quantum interconnect link. When ideally implemented, communications over a quantum interconnect link are uniquely secure because measurements of a quantum interconnect link detectably disturb the link, e.g., the measurement disturbs the information carrier's quantum state in a way which can be later detected. For example, projective measurement techniques alter the quantum state of the transmitted particles if the projective measurement is performed in a basis different from the basis used to prepare the quantum particles. To avoid detection, eavesdroppers on a quantum interconnect link may utilize weak measurements. Weak measurements allow an eavesdropper to gather a smaller amount of information about the transmitted quantum data while inducing a smaller disturbance to the quantum state, thereby potentially diminishing the security of the quantum interconnect link. Different types of disturbances to the transmitted quantum data are commonly caused by an imperfect source, detector, or channel, or by a noisy environment. Through applied effort, ingenuity, and innovation, many of these identified problems have been solved by developing solutions that are included in embodiments of the present disclosure, many examples of which are described in detail herein.

### BRIEF SUMMARY

Various embodiments are directed to quantum communication techniques for detecting anomalies during transmission of quantum data. Specifically, various embodiments provide techniques for detecting disturbances in an auxiliary degree of freedom. With reference to an example method for communicating on a quantum interconnect link, the method may comprise receiving a subset of quantum particles of a plurality of particles transmitted on the quantum interconnect link, wherein the subset of quantum particles is transmitted having a transmitted physical condition comprising one or more selected physical observables imparted to the subset of quantum particles within each of a first set of one or more quantum degrees of freedom, wherein each of the first set of one or more quantum degrees of freedom are interconnected to a second set of one or more quantum degrees of freedom comprising one or more interconnected observables, and wherein each of the interconnected observables are indirectly imparted by imparting the one or more selected observables to the subset of quantum particles. In addition, the method may further comprise determining a received physical condition of the subset of quantum particles, wherein the received physical condition comprises received observables of each of the second set of one or more quantum degrees of freedom upon receipt of the subset of quantum particles. The method may further comprise accessing data reflecting the transmitted physical condition, wherein the data reflecting the transmitted physical condition reflects the imparted one or more selected observables and an indication of the one or more interconnected observables. Further, the method may comprise comparing the received physical condition with the transmitted physical condition. Additionally, upon detecting a difference between the received observables and the coupled observables, the method may further comprise generating a notification of interference along the quantum interconnect link.

In some embodiments, a value representing one or more qudits may be encoded by imparting the selected observables to the subset of quantum particles.

In some embodiments, determining a received physical condition may comprise identifying a second set of one or more quantum degrees of freedom, and determining one or more coupled observables for each of the second set of one or more quantum degrees of freedom.

In some embodiments, the quantum degrees of freedom may include one or more of polarization, time-of-arrival, spatial displacement, relative phase, orbital angular momentum, spatial modes, energy/frequency, quantized quadratures and/or spin.

In some embodiments, the transmitted physical condition may be received on a secondary communication channel separate from the quantum interconnect link.

In some embodiments, the notification of interference may indicate detection of an eavesdropper accessing the quantum interconnect link.

In some embodiments, the subset of quantum particles may be transmitted by a transmitting device and the method may further comprise, upon detecting a difference between the received observables and the coupled observables, transmitting data reflecting the detected difference to the transmitting device to cause the transmitting device to adjust one or more transmission parameters to compensate for anomalies in the quantum interconnect link.

In some embodiments, the method may further comprise upon detecting a difference between the received observables and the coupled observables, remediating at least one irregularity on the quantum interconnect link to obscure an eavesdropper's ability to identify an encoded valued transmitted via the quantum interconnect link.

An example apparatus for communicating on a quantum interconnect link is further provided. In some embodiments, the apparatus may comprise a probe coupled with the quantum interconnect link, wherein the probe is configured to receive a subset of quantum particles of a plurality of quantum particles transmitted on the quantum interconnect link, wherein the probe is configured to measure one or more selected observables imparted to the subset of quantum particles within each of a first set of one or more quantum degrees of freedom, and wherein the probe is configured to measure one or more interconnected observables defined for each of a second set of one or more quantum degrees of freedom, wherein each of the interconnected observables is indirectly imparted by imparting the one or more selected observables to the subset of quantum particles. In some embodiments, the apparatus may further comprise communication circuitry configured to access a transmitted physical condition, wherein data reflecting the transmitted physical condition reflects the imparted one or more selected observables and an indication of the one or more coupled observables. In addition, the apparatus may further include processing circuitry configured to determine a received physical condition of the subset of quantum particles, wherein the received physical condition has received observables defined for each of the second set of one or more quantum degrees of freedom, compare the received physical condition with the transmitted physical condition; and upon detecting a difference between the received observables and the coupled observables, generate a notification of interference along the quantum interconnect link.

In some embodiments, a value representing one or more qudits may be encoded by imparting the selected observables to the subset of quantum particles.

In some embodiments, determining a received physical condition may further comprise identifying a second set of one or more quantum degrees of freedom, and determining one or more coupled observables for each of the second set of one or more quantum degrees of freedom.

In some embodiments, the quantum degrees of freedom may include one or more of: polarization, time-of-arrival, spatial displacement, relative phase, orbital angular momentum, spatial modes, energy/frequency, quantized quadratures and/or spin.

In some embodiments, the transmitted physical condition may be accessed on a secondary communication channel separate from the quantum interconnect link.

In some embodiments, the notification of interference may indicate detection of an eavesdropper accessing the quantum interconnect link.

In some embodiments wherein the subset of quantum particles is transmitted by a transmitting device, the method may further comprise, upon detecting a difference between the received observables and the coupled observables, transmitting data reflecting the detected difference to the transmitting device to cause the transmitting device to adjust one or more transmission parameters to compensate for anomalies in the quantum interconnect link.

An example computer program product for communicating on a quantum interconnect link is further provided. In some embodiments, the computer program product may comprise at least one non-transitory computer-readable storage medium storing program instructions that, when executed, cause the computer program product to receive a subset of quantum particles of a plurality of quantum particles transmitted on the quantum interconnect link, wherein the subset of quantum particles is transmitted having a transmitted physical condition comprising one or more selected physical observables imparted to the subset of quantum particles within each of a first set of one or more quantum degrees of freedom, wherein each of the first set of one or more quantum degrees of freedom are coupled to a second set of one or more quantum degrees of freedom comprised of one or more coupled observables, and wherein each of the coupled observables are indirectly imparted by imparting the one or more selected observables to the subset of quantum particles. In addition, the computer program product may determine a received physical condition of the subset of quantum particles, wherein the received physical condition comprises received observables of each of the second set of one or more quantum degrees of freedom upon receipt of the subset of quantum particles. The computer program product may further access data reflecting the transmitted physical condition, wherein the data reflecting the transmitted physical condition reflects the imparted one or more selected observables and an indication of the one or more coupled observables. The computer program may further compare the received physical condition with the transmitted physical condition, and upon detecting a difference between the received observables and the coupled observables, generate a notification of interference along the quantum interconnect link.

In some embodiments, a value representing one or more qudits may be encoded by imparting the selected observables to the subset of quantum particles.

In some embodiments, determining a received physical condition may further comprise identifying a second set of one or more quantum degrees of freedom, and determining one or more coupled observables for each of the second set of one or more quantum degrees of freedom of the subset of quantum particles.

In some embodiments, the quantum degrees of freedom may include one or more of: polarization, time-of-arrival, spatial displacement, relative phase, orbital angular momentum, spatial modes, energy/frequency, quantized quadratures and/or spin.

In some embodiments, the transmitted physical condition may be received on a secondary communication channel separate from the quantum interconnect link.

In some embodiments, the notification of interference by the transmitting side may indicate upon reflection detection of an eavesdropper accessing the quantum interconnect link.

In some embodiments, the subset of quantum particles may be transmitted by a transmitting device and the method may further comprise, upon detecting a difference between the received observables and the coupled observables, transmitting data reflecting the detected difference to the transmitting device to cause the transmitting device to adjust one or more transmission parameters to compensate for anomalies in the quantum interconnect link.

### BRIEF DESCRIPTION OF THE DRAWINGS

Having thus described certain example embodiments in general terms, reference will now be made to the accompanying drawings. The components illustrated in the figures may or may not be present in certain embodiments described herein. Some embodiments may include fewer (or more) components than those shown in the figures.

FIG. 1 illustrates an example quantum interconnect communication network including an eavesdropper in accordance with one or more embodiments.

FIG. 2 illustrates a block diagram of an example quantum interconnect device in accordance with an example embodiment.

FIG. 3 illustrates a block diagram of an example quantum measurement processing device in accordance with an example embodiment.

FIG. 4 illustrates a flowchart of an example method for detecting an anomaly on a quantum interconnect link in accordance with an example embodiment.

FIG. 5A illustrates a block diagram of an example feed forward mechanism for correcting quantum states according to statistical data measured and recorded in accordance with an example embodiment.

FIG. 5B illustrates an example system diagram illustrating a feed forward mechanism for correcting quantum states according to statistical data measured and recorded in accordance with an example embodiment.

### DETAILED DESCRIPTION

### Overview

Various embodiments will now be described more fully hereinafter with reference to the accompanying drawings in which some but not all embodiments are shown. Indeed, embodiments may take many different forms and should not be construed as limited to the explicit disclosure set forth herein; rather these embodiments are provided so that this disclosure will satisfy applicable legal requirements. Like reference numerals refer to like elements throughout.

Example embodiments are directed to methods, apparatus, and computer program products for utilizing auxiliary degrees of freedom to detect an anomaly on a quantum interconnect link.

Quantum communication links generally provide a secure pathway to communicate data by relying on certain known and predictable observables of quantum mechanics. Quantum communication devices transmit and receive information using quantum bits (qubits) or higher order qudits by encoding values in the physical observables of quantum particles. Transmission of a quantum particle comprises a plurality of degrees of freedom which are distinct physical parameters that make up the state of a quantum particle being transmitted, for example, the spin, polarization, spatial position, phase, time of arrival, angular momentum, and/or orbital momentum may all be degrees of freedom of a transmitted quantum particle. In addition, each degree of freedom has one or more bases (plural form of “basis”) which are mutually orthogonal vectors defined within the specific degree of freedom. For example, one set of basis vectors used to define the polarization degree of freedom is the “rectilinear basis” in which a quantum particle polarized at zero degrees (e.g., horizontal) represents a first value (e.g., 1) while a quantum particle polarized at ninety degrees (e.g., vertical) represents a second distinct value (e.g., 0). As described herein, a characteristic represents a physical observable of the quantum particle within the selected degree of freedom used for information encoding and decoding. In order to transmit information in a quantum communication network, a transmitter selects a degree of freedom and a basis. For example, a transmitter may select the polarization degree of freedom and the rectilinear basis. A transmitter may then modify the physical characteristic of a transmitted particle's degree of freedom to encode a value. For example, a transmitter may give a quantum particle a first characteristic by polarizing a quantum particle at an angle of ninety degrees (e.g., vertical polarization) to encode a ‘1’ or may give a second quantum particle a second characteristic by polarizing the quantum particle at an angle of zero degrees (e.g., horizontal polarization) to encode a ‘0.’ Further, the physical condition of a quantum particle refers to all physical observables across one or more degrees of freedom of a quantum particle, collectively.

In addition, degrees of freedom may be coupled such that observables of one degree of freedom may be reflected in a second, auxiliary degree of freedom (referred to herein as a “coupled” degree of freedom). For example, a quantum device may infer observables related to the spin of a quantum particle based on measurements of the spatial position using a probe such as a Stern-Gerlach-like device. In another example, a quantum device may infer observables related to the polarization of a quantum particle again based on the spatial position using a bi-refrigerant crystal. Thus, measurements may be performed in a first degree of freedom to infer information about a second degree of freedom. Similarly, imparting a physical characteristic in one degree of freedom may indirectly impart a related characteristic on another, auxiliary degree of freedom.

However, the physical observables of transmitted quantum states are sensitive and can be easily influenced by any external stimulation. External stimulation can occur by way of extraneous magnetic or electric fields at the quantum interconnect link, changes in temperature in the system, cross talk between nearby optical or electrical lines, or other disturbances. In addition, performing measurements on the quantum interconnect line may disturb the physical observables of transmitted quantum states. Thus, external influences and/or processes for measuring the state of the quantum particles may detectably change the state of the system. For example, standard measuring techniques, such as projective measurement, can cause the quantum particle characteristic to collapse to one of the eigenstates of the measured operator. Traditionally, by comparing a subset of the transmitted values with corresponding received values, a transmitter and receiver in a quantum communication network can reliably detect an eavesdropper using projective measurements.

Since quantum communications have presented a reliable way to detect the presence of an eavesdropper, quantum interconnect links have been utilized to facilitate the transmission and reception of secure keys while ensuring that no eavesdroppers are present. This process is known as quantum key distribution. Using quantum communication techniques, a sender and receiver could theoretically guarantee the security of a transmitted key and reliably use the key in secure operations. Transmissions utilizing a quantum communication link can make it difficult for a third party to intercept the quantum communication without detection.

A number of techniques have been developed to enable an eavesdropper to perform variable-strength quantum measurements or weak measurements. Weak measurements allow an eavesdropper to gather information about the physical observables of a transmitted quantum state while only minimally changing the state of the quantum interconnect link. The information gain, however, is smaller when lowering the measurement strength. Generally, an eavesdropper is able to avoid detection for two primary reasons: (1) the eavesdropper may perform a weak measurement on a degree of freedom that is not utilized by the transmitter and the receiver to encode a value (e.g., an auxiliary degree of freedom), thus, the transmitter and receiver may never measure and/or analyze the affected auxiliary degree of freedom; and (2) weak measurements are variable-strength, meaning the eavesdropper may adjust the measurements to maximize measured information while minimizing the detectable impact the measurements may have on the system in realistic cases with loss, noise and setup imperfections. As an example, an eavesdropper may use a component, such as a birefringent crystal, a polarizing beam splitter, a quantum router or a Stern-Gerlach-like device to perform a weak measurement. When passed through such a device, the quantum particles will displace differently based on the polarization/spin of the particle. If the displacement is smaller than the uncertainty of the measuring pointer then the measurement will be considered weak. An eavesdropper may measure the spatial displacement of the quantum particles and estimate the polarization/spin of the quantum particles in a certain basis depending on the spatial displacement. This technique causes a minor variation in the spatial displacement of the quantum particles, typically much below the standard deviation of the position operator, but also has in such cases a negligible effect on the polarization/spin of the quantum particles. Thus, a quantum interconnect receiver decoding values based on the polarization/spin of the quantum particles will be unable to easily detect the presence of the eavesdropper. In addition, an eavesdropper may vary the strength of the measurement device to minimize the impact on the spatial displacement of the measured quantum particles.

Various methods, apparatuses, and computer program products are provided to counteract these advances in eavesdropping capability by providing techniques to detect eavesdroppers that use weak measurement techniques. One such technique of a quantum interconnect receiver is to perform measurements on a received quantum particle in the degree of freedom on which the value is encoded and to also perform measurements and analyze the results in auxiliary degrees of freedom. Thus, if an eavesdropper is performing weak measurements on an auxiliary degree of freedom and the encoded degree of freedom is barely affected, the quantum interconnect receiver (or transmitter, upon reflection of a subset of the states) may still detect the perceptible change in the other degrees of freedom. Detection of such anomalies may be indicative of an eavesdropper performing weak measurements, allowing the quantum interconnect receiver to make such a determination and provide notification to the quantum interconnect transmitter or another quantum interconnect device.

In addition to detecting the presence of an eavesdropper, a quantum interconnect device performing measurements on multiple degrees of freedom may detect anomalies in the quantum interconnect link due, in some instances, to interactions between the quantum communication network and the surrounding environment, misalignment of encoding equipment, timing of quantum communication equipment, and/or similar environment and equipment non-idealities. Information obtained from these measurements may be used to inform determination of the encoded value in future transmissions on this and other quantum interconnect devices.

These techniques and others enable a quantum interconnect device to establish the security and reliability of the quantum communications across a quantum communication network.

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein as receiving data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein as sending data to another computing device, it will be appreciated that the data may be sent directly to another computing device or may be sent indirectly via one or more intermediary computing devices, such as, for example, one or more servers, relays, routers, network access points, base stations, hosts, and/or the like.

Embodiments are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

The terms “illustrative,” “exemplary,” and “example” as may be used herein are not provided to convey any qualitative assessment, but instead merely to convey an illustration of an example. Thus, use of any such terms should not be taken to limit the spirit and scope of embodiments of the present invention. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### System Architecture for Probing Auxiliary Degrees of Freedom in a Quantum Communication System

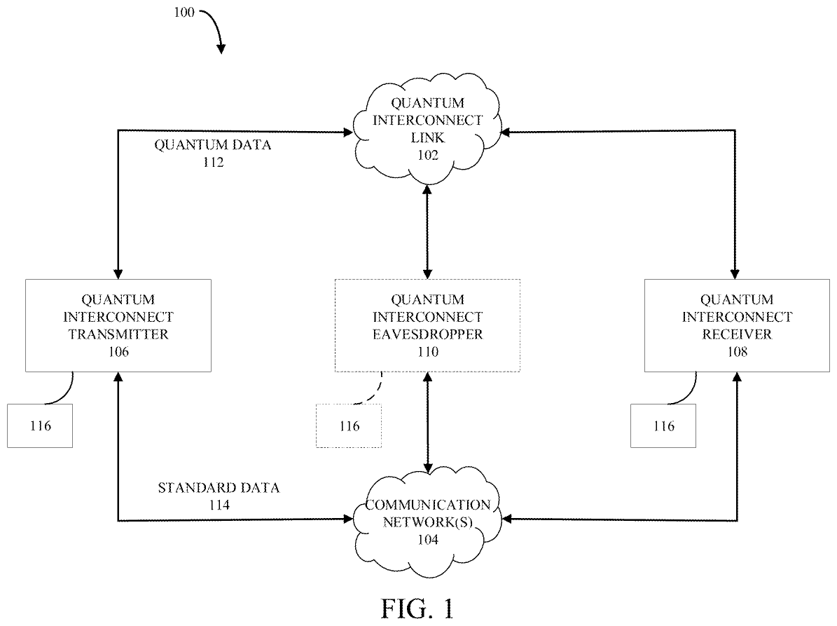

FIG. 1 illustrates an example quantum communication network 100 according to an embodiment of the present invention. As depicted in FIG. 1, the example quantum communication network 100 may include a quantum interconnect link 102 facilitating the transfer of quantum data 112 between a quantum interconnect transmitter 106 and a quantum interconnect receiver 108. In addition, the quantum interconnect transmitter 106 and quantum interconnect receiver 108 may be communicatively connected to a communication network 104 providing electronic and/or optical communication (e.g., standard data 114) between the quantum interconnect transmitter 106 and the quantum interconnect receiver 108. Further, FIG. 1 depicts a quantum interconnect eavesdropper 110 communicatively connected to the quantum interconnect link 102 and the communication network 104 over which the quantum interconnect transmitter 106 and the quantum interconnect receiver 108 transmit and receive communications. Each quantum interconnect device (e.g., quantum interconnect transmitter 106, quantum interconnect receiver 108, quantum interconnect eavesdropper 110) further includes a quantum measurement processing device 116.

The illustration of FIG. 1 includes a depiction of a quantum interconnect link 102. A quantum interconnect link 102 may be any physical cable, conduit, wire, channel, line or the like that is capable of transmitting quantum data 112 encoded via a stream of transmitted quantum particles. As non-limiting examples, a quantum interconnect link 102 may comprise an optical line or a quantum line. The quantum interconnect link 102 is configured to allow quantum particles to pass along the quantum interconnect link 102 between a quantum interconnect transmitter 106 and a quantum interconnect receiver 108. Travel of each of the quantum particles along the quantum interconnect link 102 may be characterized according to a plurality of degrees of freedom of the quantum particle. For example, the polarization, time-of-arrival, spatial displacement, relative phase, orbital angular momentum, spatial modes, energy/frequency, quantized quadratures and/or spin of the quantum particle, as examples, may be manipulated by the quantum interconnect transmitter 106. By selectively manipulating various degrees of freedom of the particle, the observables of the particle with respect to each of the various degrees of freedom may be selectively set to encode data values to the quantum particle. Data may be transmitted across the quantum interconnect link 102 by selectively imparting certain observables to a plurality of quantum particles transmitted across the quantum interconnect link. Collectively, the observables of each of the plurality of quantum particles define the data transmitted across the quantum interconnect link 102.

In some embodiments, a quantum interconnect link 102 may be utilized to transmit and receive quantum data by encoding the data in a particular degree of freedom (e.g., polarization, time-of-arrival, spatial displacement, relative phase, orbital angular momentum, spin, spatial modes, energy/frequency, quantized quadratures or other similar physical property). In a selected degree of freedom, a basis is chosen representing the potential states of the transmitted quantum data. For example, a quantum communication network 100 that has selected the spin of the quantum particle as the degree of freedom in which to encode data, may select spin up and spin down as the two orthogonal states representing two different encoded values. Quantum particles that can represent one of two orthogonal states (or both states simultaneously), referred to as “qubits,” are the basic unit of quantum information in a quantum communication network 100. However, in some embodiments, a quantum interconnect link 102 may be utilized to transmit and receive quantum data in a multi-state combination (qudits), for example, by varying a combination of physical observables across multiple degrees of freedom. In addition, quantum particles transmitted on a quantum interconnect link 102 may rely on quantum properties such as quantum superposition and/or quantum entanglement to facilitate the transmission of information. These quantum properties allow for the transmission and/or verification of additional data for a given quantum transmission.

In some embodiments, the quantum interconnect link 102 may be utilized to facilitate a quantum key distribution (QKD) process in which a secret key is created between two devices (e.g., a quantum interconnect transmitter 106 and a quantum interconnect receiver 108) connected to a quantum interconnect link 102. In these and other embodiments, a third party (e.g., a quantum interconnect eavesdropper 110) may desire to intercept quantum communications transmitted on the quantum interconnect link 102 without detection.

FIG. 1 further depicts a quantum interconnect transmitter 106. A quantum interconnect transmitter 106 may be any device capable of interfacing with a quantum interconnect link 102 and a communication network 104 and capable of generating and transmitting quantum particles (e.g., photons, electrons, atoms, etc.). While primarily described as a quantum interconnect transmitter 106 and a quantum interconnect receiver 108, in some embodiments, each may be a transceiver capable of both transmitting and receiving quantum particles and may be referred to herein as a quantum device. In some embodiments, a quantum interconnect transmitter 106 may encode data on a quantum particle by varying a physical characteristic of the transmitted quantum particle with respect to a specific quantum basis. A quantum basis may refer to a set of mutually orthogonal vectors defined within the specific degree of freedom. In some embodiments, a quantum interconnect transmitter 106 may spin a quantum particle up to encode a ‘1’ and spin a quantum particle down to encode a ‘0.’

In some embodiments, a quantum interconnect transmitter 106 may establish a plurality of bases within a degree of freedom, for encoding a value. For example, in an instance in which polarity is selected as the degree of freedom in which to encode a value, a quantum interconnect transmitter 106 may choose to vary the polarization such that data is encoded according to a rectilinear, diagonal, or circular polarization basis. The “rectilinear basis” may refer to the pair of rectilinear polarizations comprising a horizontal polarization of zero degrees and a vertical polarization of ninety degrees. The “diagonal basis” may refer to the pair of diagonal polarization states comprising the diagonal polarization of 45 degrees and the diagonal polarization of 135 degrees. The “circular basis” may refer to the pair of circular polarization states comprising the left circular polarization and the right circular polarization. Similarly, orthogonal quantum bases may be defined for all degrees of freedom for which a quantum interconnect transmitter 106 may vary the physical observables of the quantum particle. In some embodiments, a quantum interconnect transmitter 106 may additionally have the capability to utilize quantum principles such as quantum superposition and/or quantum entanglement to facilitate the transmission of quantum data.

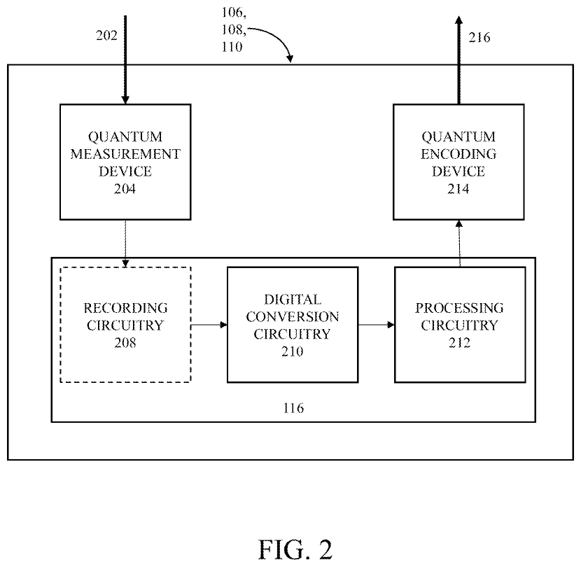

As depicted in FIG. 1, in some embodiments, a quantum interconnect transmitter 106 may further include a quantum measurement processing device 116. The quantum measurement processing device 116 may be any processing device comprising hardware, software, and/or firmware configured to determine the required physical observables of a quantum particle to encode a specified value. A quantum measurement processing device may further configure a modulating device (e.g., quantum encoding device 214 depicted in FIG. 2) to produce output quantum particles according to the determined physical observables. In some embodiments, encoding a specified value may include determining the degree of freedom and basis on which data will be encoded and further determining the physical observables at which the quantum particles will be generated to represent the encoded values. In addition, the quantum measurement processing device 116 may receive information representing one or more observables of a received quantum particle from one or more components of an optical receiver. A quantum measurement processing device 116 may infer an encoded value based at least in part on the received observables.

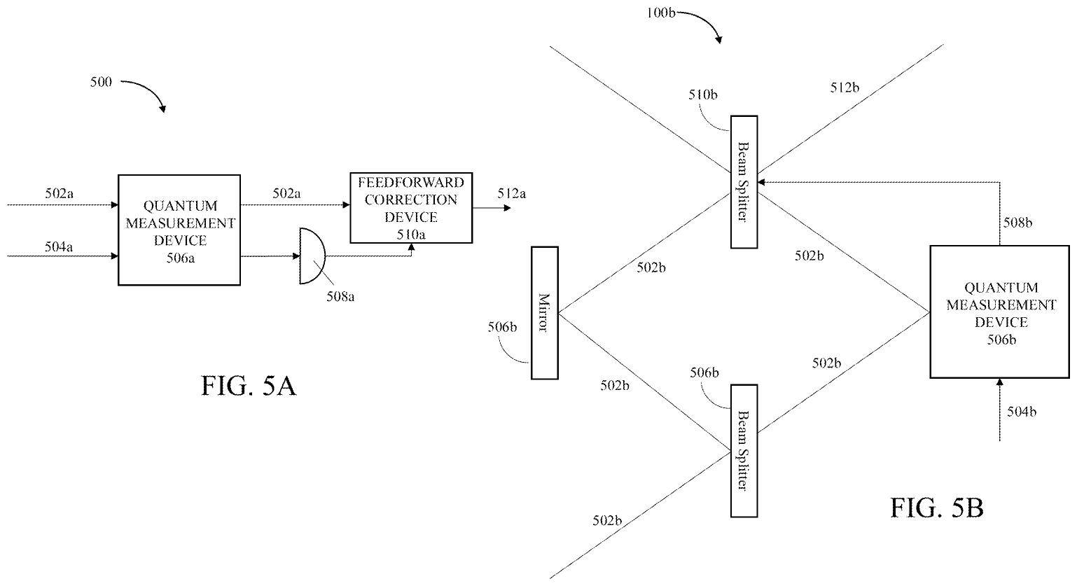

In some embodiments, the quantum measurement processing device 116 may further facilitate communication on a communication network 104 using standard data 114. A quantum measurement processing device 116 may utilize a communication network 104 to exchange bases used to transmit and receive the data once transmission has occurred. A quantum measurement processing device 116 may further utilize a communication network 104 to transmit feedforward information relating to the correction of quantum states, as further described in FIG. 5A and FIG. 5B.

FIG. 1 further depicts a quantum interconnect receiver 108. Similar to a quantum interconnect transmitter 106, a quantum interconnect receiver 108 may be any device capable of interfacing with a quantum interconnect link 102 and a communication network 104 and capable of receiving and decoding quantum particles. In some embodiments, a quantum interconnect receiver 108 may be configured to determine the physical observables of a received quantum particle with respect to a specific degree of freedom, which may include, for example, determining the spin of the quantum particle, the polarization of a quantum particle, the timing and/or spatial position of a quantum particle, the phase of a quantum particle, and/or other similar measurements.

In some embodiments, decoding a value from a received quantum particle may include determining the degree of freedom and basis on which data will be decoded. In some embodiments, the degree of freedom and basis may be predetermined and communicated between the quantum interconnect transmitter 106 and the quantum interconnect receiver 108 using standard data 114 on the communication network 104. In some embodiments, the degree of freedom may be predetermined while the basis is separately determined by the quantum interconnect receiver 108. In some embodiments, neither the degree of freedom nor the basis may be predetermined and both may be separately selected and/or predicted at the time of transmission. In quantum key distribution (QKD) environments, a quantum interconnect receiver 108 may later compare quantum bases randomly selected by the quantum interconnect receiver 108 with transmitted quantum bases and utilize the information from the transmissions in which the selected quantum basis match the transmitted quantum basis to determine a secure key.

In addition, in some embodiments, a quantum interconnect receiver 108 may be configured to reflect and/or re-transmit transmitted quantum particles through the quantum interconnect link 102, back to the quantum interconnect transmitter 106 or another device connected to the quantum interconnect link 102.

As described in relation to the quantum interconnect transmitter 106, while the quantum interconnect receiver 108 is primarily described as a receiver, in some embodiments, the quantum interconnect receiver 108 may be a transceiver capable of both transmitting and receiving quantum particles and may be referred to herein as a quantum interconnect device.

As depicted in FIG. 1, in some embodiments, a quantum interconnect receiver 108 may further include a quantum measurement processing device 116. A quantum measurement processing device 116 may enable a quantum interconnect receiver 108 to determine the physical observables of a quantum particle required to decode a specified value based on information received from a quantum particle capture device (e.g., probe 204 described in relation to FIG. 2). In some embodiments, a quantum measurement processing device 116 may also be utilized to determine and/or store bases used in the determination of a quantum particle's value.

FIG. 1 further depicts a quantum interconnect eavesdropper 110. A quantum interconnect eavesdropper 110 may be any device capable of intercepting quantum particle transmissions between a quantum interconnect transmitter 106 and a quantum interconnect receiver 108 along a quantum interconnect link 102. A quantum interconnect eavesdropper 110 may physically interface with the quantum interconnect link 102 to intercept (receive), measure, and resend (transmit) transmitted quantum particles. One method of measuring quantum particles transmitted on a quantum interconnect link 102 is to use projective, or strong, measurements. Projective measurements can be easily detected in the transmission of quantum particles because projective measurements often alter the physical observables of the measured quantum particles. That is, upon performing a projective measurement, the measuring device may influence the physical observables of the quantum state, in some instances, changing the measured characteristic of the transmitted quantum particle and consequently changing the encoded value transmitted via the quantum particle. For example, a quantum particle may be transmitted encoding a value in a degree of freedom based on the up-down spin of the quantum particle, for example, with a spin up characteristic representing a ‘1.’ A quantum interconnect eavesdropper 110 performing projective measurements may collapse the quantum state into a different state if the measurement is performed in a different basis than the transmitted encoding basis. For example, if the quantum particle is transmitted relative to an up-down spin basis and the quantum interconnect eavesdropper 110 performs measurements relative to a different basis, the spin of the quantum particle may collapse into a spin down characteristic, and thus represent a ‘0,’ upon the measurement by the quantum interconnect receiver 108. Such a disturbance will likely be detected when the quantum interconnect transmitter 106 and the quantum interconnect receiver 108 exchange bases after transmission.

A second method of measuring quantum particles is to use variable-strength quantum measurements, or weak measurements. A weak measurement allows a quantum interconnect eavesdropper 110 to glean information from the transmitted quantum particles while rarely collapsing the state of the quantum particle to one of the basis states, thereby, making it more difficult for a quantum interconnect transmitter 106 and/or a quantum interconnect receiver 108 to detect the eavesdropper. In addition, weak measurements are generally performed on a degree of freedom that is not utilized by the transmitter and the receiver to encode a value (e.g., an auxiliary degree of freedom).

As one example, in an instance in which the quantum particle polarization is the degree of freedom utilized to convey data, a quantum interconnect eavesdropper 110 may determine the polarization of a quantum particle by passing the quantum data stream through a bi-refrigerant crystal. In some embodiments, a bi-refrigerant crystal may cause a spatial displacement in the quantum data stream based on the polarization of the quantum data. Thus, a quantum interconnect eavesdropper 110 may determine information related to the polarization of the quantum data 112 without measuring the polarization directly, which may alter the physical observables of the quantum data. Information recovered from the spatial displacement may aid the quantum interconnect eavesdropper 110 in determining the encoded value of the quantum data, while leaving the polarization degree of freedom virtually undisturbed.

FIG. 1 further depicts a communication network 104. A communication network 104 may be any network or system of networks allowing wired and/or wireless communication of standard data 114 between connected nodes, for example, a wired or wireless local area network (LAN), personal area network (PAN), metropolitan area network (MAN), wide area network (WAN), or the like. Standard data 114 may be any data transmitted based on the properties of the communication stream and not based on the physical properties of the quantum particles, for example, electrical data, optical data, wave data, etc. A communication network 104 may also include any hardware, software and/or firmware required for implementing the one or more networks (e.g., network routers, switches, hubs, etc.). For example, communication network 104 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the communication network 104 may include a public network, such as the Internet, a private network, such as an intranet, or combinations thereof, and may utilize a variety of networking protocols now available or later developed including, but not limited to TCP/IP based networking protocols. A communication network 104 may enable a quantum interconnect device to communicate information using the above mentioned protocols.

With reference to FIG. 2, a block diagram of an example quantum interconnect device (e.g., quantum interconnect transmitter 106, quantum interconnect receiver 108, quantum interconnect eavesdropper 110) is provided. As shown in FIG. 2, the example quantum interconnect device includes a probe 204 positioned to receive quantum transmission data 202 on a quantum interconnect link 102. The probe 204 is additionally in electric communication with a quantum measurement processing device 116 as initially described with reference to FIG. 1. The depicted quantum measurement processing device 116 includes recording circuitry 208, digital conversion circuitry 210, and processing circuitry 212. The quantum measurement processing device 116 is further electrically connected to a quantum encoding device 214. The quantum encoding device 214 generates quantum output data 216 based on the physical observables determined by the quantum measurement processing device 116 and transmits the quantum data on the quantum interconnect link 102.

As depicted in FIG. 2, the example quantum interconnect device receives quantum transmission data 202 on a quantum interconnect link (e.g., quantum interconnect link 102). Quantum transmission data 202 may be any quantum data generated to encode one or more values using the physical properties of the quantum particles and transmitted on a quantum interconnect link 102. Quantum particles may include photons, atoms, electrons, and/or other similar particles. In some embodiments, data may be encoded on a quantum particle by manipulating the physical observables of the particle being transmitted in one or more degrees of freedom. The observables which may be adjusted are dependent on the degree of freedom on which the transmitted value is to be encoded. In some embodiments, a basis is selected encoding different values based on orthogonal physical observables. For example, a quantum interconnect transmitter 106 that has determined to encode data based on polarization as the degree of freedom, may select the “rectilinear basis” comprising the horizontal polarization of zero degrees and the vertical polarization of ninety degrees as the possible encoded states. Quantum particles received in the quantum transmission data 202 having a horizontal polarization may encode one value (e.g., ‘0’) while quantum particles having a vertical polarization may encode a second value (e.g., ‘1’). Similarly, quantum transmission data 202 may utilize a “diagonal basis,” wherein a diagonal polarization of 45 degrees and a diagonal polarization of 135 degrees encode separate values, or a “circular basis,” wherein a left circular polarization and a right circular polarization encode separate values. Similarly, one or more orthogonal quantum bases may be defined for all quantum states for which quantum transmission data 202 may be transmitted. In some embodiments, quantum transmission data 202 may additionally utilize quantum principles such as quantum superposition to transmit a quantum particle exhibiting multiple physical observables of a single degree of freedom and/or quantum entanglement allowing a transmitter to retain properties of a transmitted quantum particle for later comparison. Each of these quantum principles can further facilitate the transmission of quantum data.

As further depicted in FIG. 2, the example quantum interconnect device includes a probe 204. A probe 204 is any device capable of receiving optical data and performing measurements to determine one or more observables associated with one or more selected degrees of freedom. A quantum interconnect receiver 108 may select and/or receive a degree of freedom and basis in which the transmitted data may be encoded. A quantum interconnect receiver 108 may only measure the physical properties within the selected degree of freedom to determine the value encoded on the quantum particle. For example, if a quantum interconnect receiver 108 has determined a quantum particle has been encoded with a value in the polarity degree of freedom using a rectilinear basis, the quantum interconnect receiver 108 may only measure the polarization of a transmitted quantum particle and determine if the polarization is vertical or horizontal. However, if there is a quantum interconnect eavesdropper 110 performing weak measurements on an auxiliary degree of freedom (e.g., spatial location) or an environment variable is disturbing the quantum interconnect link 102, a quantum interconnect receiver 108 may not be able to detect the disturbance. Thus, a probe 204 may be equipped with multiple optical components to measure the physical properties in the degree of freedom in which the value is encoded (e.g., primary degree of freedom) and at least one auxiliary degree of freedom.

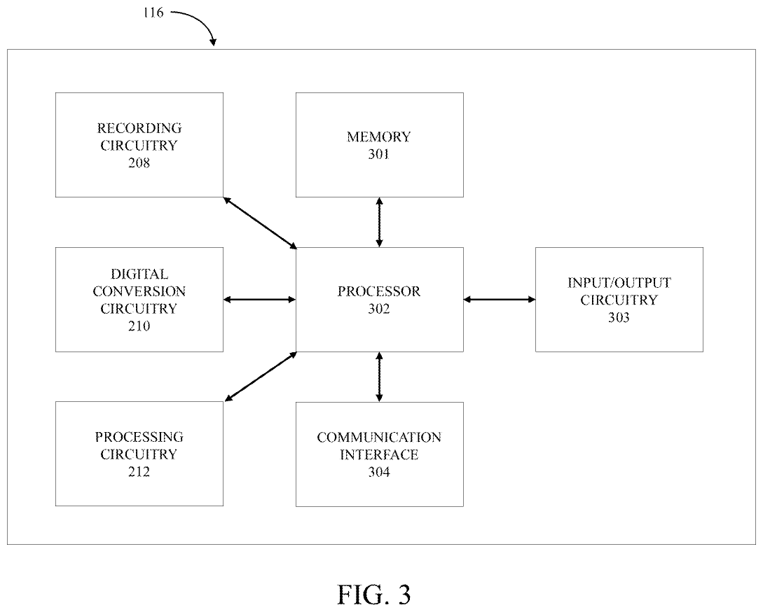

As further depicted in FIG. 2, the example quantum interconnect device further includes a quantum measurement processing device 116. The quantum measurement processing device 116 may be any device comprising hardware, software, and/or firmware configured to receive information representing one or more physical observables of a quantum particle from one or more components of the probe 204. A quantum measurement processing device 116 may not only infer an encoded value based at least in part on the received observables in the primary degree of freedom, but also detect an eavesdropper and/or other network anomalies based on measurements on the auxiliary degrees of freedom. As further described in relation to FIG. 3, a quantum measurement processing device 116 may utilize recording circuitry 208, digital conversion circuitry 210, and/or processing circuitry 212 to perform the operations necessary to infer an encoded value and detect further anomalies. The quantum measurement processing device 116 may be electrically and/or communicatively connected to both the probe 204 and the quantum encoding device 214.

As shown in FIG. 2, the example quantum interconnect device further includes a quantum encoding device 214. A quantum encoding device 214 may be any device capable of generating and/or encoding values on quantum particles based on the observables determined by the quantum measurement processing device 116 required to represent a desired transmitted value. In some embodiments, a quantum encoding device 214 may be configured to manipulate degrees of freedom to correspond to produce the desired output value. Depending on the desired output value, a quantum encoding device 214 may be required to manipulate one or more degrees of freedom (e.g., spin of an electron, polarization of the quantum particle, phase, position, time of arrival, angular momentum, orbital momentum, etc.) and one or more observables of the particular degree of freedom (e.g., rectilinear basis, diagonal basis, circular basis, etc.). The quantum particles generated by the quantum encoding device 214 and encoding values are transmitted to the quantum interconnect link 102 as quantum output data 216.

FIG. 3 illustrates a quantum measurement processing device 116 in accordance with at least some example embodiments. The quantum measurement processing device 116 includes processor 302, input/output circuitry 303, memory 301, communication interface 304, recording circuitry 208, digital conversion circuitry 210, and processing circuitry 212. In some embodiments, the quantum measurement processing device 116 is configured, using one or more of the sets of circuitry 301, 302, 303, 304, 212, 214, and/or 216, to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, two sets of circuitry may both leverage use of the same processor(s), network interface(s), storage medium(s), and/or the like, to perform their associated functions, such that duplicate hardware is not required for each set of circuitry. The user of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the quantum measurement processing device 116 provide or supplement the functionality of other particular sets of circuitry. For example, the processor 302 in some embodiments provides processing functionality to any of the sets of circuitry, the memory 301 provides storage functionality to any of the sets of circuitry, the communication interface 304 provides network interface functionality to any of the sets of circuitry, and/or the like.

In some embodiments, the processor 302 (and/or co-processor or any other processing circuitry assisting or otherwise associated with the processor) is/are in communication with the memory 301 via a bus for passing information among components of the quantum measurement processing device 116. In some embodiments, for example, the memory 301 is non-transitory and may include, for example, one or more volatile and/or non-volatile memories. In other words, for example, the memory 301 in some embodiments includes or embodies an electronic storage device (e.g., a computer readable storage medium). In some embodiments, the memory 301 is configured to store information, data, content, applications, instructions, or the like, for enabling the quantum measurement processing device 116 to carry out various functions in accordance with example embodiments of the present disclosure.

The processor 302 may be embodied in a number of different ways. For example, in some example embodiments, the processor 302 includes one or more processing devices configured to perform independently. Additionally or alternatively, in some embodiments, the processor 302 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the quantum measurement processing device 116, and/or one or more remote or “cloud” processor(s) external to the quantum measurement processing device 116.

In an example embodiment, the processor 302 is configured to execute instructions stored in the memory 301 or otherwise accessible to the processor. Alternatively or additionally, the processor 302 in some embodiments is configured to execute hard-coded functionality. As such, whether configured by hardware or software methods, or by a combination thereof, the processor 302 represents an entity (e.g., physically embodied in circuitry) capable of performing operations according to an embodiment of the present disclosure while configured accordingly. Alternatively or additionally, as another example in some example embodiments, when the processor 302 is embodied as an executor of software instructions, the instructions specifically configure the processor 302 to perform the algorithms embodied in the specific operations described herein when such instructions are executed.

As one particular example embodiment, the processor 302 is configured to perform various operations associated with eavesdropping a value transmitted on a quantum interconnect link 102. In some embodiments, the processor 302 includes hardware, software, firmware, and/or a combination thereof, that receives a subset of quantum particles of a plurality of quantum particles transmitted on the quantum interconnect link 102. Additionally or alternatively, in some embodiments, the processor 302 includes hardware, software, firmware, and/or a combination thereof, that determines a received physical condition of the subset of quantum particles, wherein the received physical condition comprises received observables of each of the second set of one or more quantum degrees of freedom upon receipt of the subset of quantum particles. Additionally or alternatively, in some embodiments, the processor 302 includes hardware, software, firmware, and/or a combination thereof, that accesses data reflecting the transmitted physical condition, wherein the data reflecting the transmitted physical condition reflects the imparted one or more selected observables and an indication of the one or more coupled observables. Additionally or alternatively, in some embodiments, the processor 302 includes hardware, software, firmware, and/or a combination thereof, that compares the received physical condition with the transmitted physical condition; and upon detecting a difference between the received observables and the coupled observables, generates a notification of interference along the quantum interconnect link.

In some embodiments, the quantum measurement processing device 116 includes input/output circuitry 303 that provides output to the user and, in some embodiments, to receive an indication of a user input. In some embodiments, the input/output circuitry 303 is in communication with the processor 302 to provide such functionality. The input/output circuitry 303 may comprise one or more user interface(s) (e.g., user interface) and in some embodiments includes a display that comprises the interface(s) rendered as a web user interface, an application user interface, a user device, a backend system, or the like. The processor 302 and/or input/output circuitry 303 comprising the processor may be configured to control one or more functions of one or more user interface elements through computer program instructions (e.g., software and/or firmware) stored on a memory accessible to the processor (e.g., memory 301, and/or the like). In some embodiments, the input/output circuitry 303 includes or utilizes a user-facing application to provide input/output functionality to a client device and/or other display associated with a user.

In some embodiments, the quantum measurement processing device 116 includes communication interface 304. The communication interface 304 includes any means such as a device or circuitry embodied in either hardware or a combination of hardware and software that is configured to receive and/or transmit data from/to a network and/or any other device, circuitry, or module in communication with the quantum measurement processing device 116. In this regard, the communication interface 304 includes, for example in some embodiments, a network interface for enabling communications with a wired or wireless communications network. Additionally or alternatively in some embodiments, the communication interface 304 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communication interface 304 includes circuitry for interacting with the antenna(s) and/or other hardware or software to cause transmission of signals via the antenna(s) or to handle receipt of signals received via the antenna(s). In some embodiments, the communication interface 304 enables transmission to and/or receipt of data from a client device in communication with the quantum measurement processing device 116.

The recording circuitry 208 includes hardware, software, firmware, and/or a combination thereof, that supports various functionality associated with determining and recording statistics related to the time of arrival, frequency distribution, physical observables, and/or basis used of the received quantum data (e.g., quantum transmission data 202). The recorded bases may later be utilized to compare transmitted values with received values between the quantum interconnect transmitter 106 and the quantum interconnect receiver 108 to detect the presence of an eavesdropper. In addition to recording physical observables and bases associated with the encoded value, the recording circuitry 208 may also record physical observables associated with auxiliary degrees of freedom. Comparison of auxiliary degrees of freedom may allow a quantum interconnect device to detect changes in the auxiliary degrees of freedom due to an eavesdropper performing weak measurements, misalignment or mistiming of transmission equipment, and/or environmental interactions with the quantum data 112.

In some embodiments, the recording circuitry 208 includes a separate processor, specially configured field programmable gate array (FPGA), or a specially programmed application specific integrated circuit (ASIC).

The digital conversion circuitry 210 includes hardware, software, firmware, and/or a combination thereof, that supports various functionality associated with converting the information provided by the probe 204 associated with the physical observables of the quantum data 112 to a digital encoding. In some embodiments, the probe 204 may transmit measurements based on the physical observables of one or more degrees of freedom of a particular quantum particle or set of quantum particles. This data may be representative of a spatial or temporal displacement, a data measurement associated with a specific polarization orientation, and/or the like. The digital conversion circuitry 210 may infer the digital encoding based on the recorded observables of the one or more degrees of freedom and output a digital value based on that determination. For example, a ‘0’, ‘1’, ‘01’, ‘11’, etc. In some embodiments, this conversion may comprise applying the measurements to a selected basis of a particular degree of freedom and determining the encoded value based on the measurements.

In some embodiments, the digital conversion circuitry 210 includes a separate processor, specially configured field programmable gate array (FPGA), or a specially programmed application specific integrated circuit (ASIC).

The processing circuitry 212 includes hardware, software, firmware, and/or a combination thereof, that supports various functionality associated with determining the encoded value associated with a quantum particle and detecting anomalies and potential eavesdroppers on the quantum interconnect link 102, based on the measured observables from the probe 204. In some embodiments, the probe 204 may perform a plurality of measurements which are transmitted to the digital conversion circuitry 210 and converted into digital qubits/qudits. In some embodiments, the measurements from a plurality of degrees of freedom may relate to encoded data across multiple degrees of freedom. However, in some embodiments, the probe 204 may perform a plurality of measurements for purposes of detecting the presence of an eavesdropper. For example, in some embodiments, a quantum interconnect receiver 108 may be provided access to the transmitted observables of one or more transmitted quantum particles. In some embodiments, the quantum interconnect receiver 108 may be provided access by transmission using the communication network 104, or similar network interface. In some embodiments, the quantum interconnect receiver 108 may be provided access to a common repository to which the quantum interconnect transmitter 106 may save observables of the transmitted quantum particles. In some embodiments, the quantum interconnect receiver 108 may reflect or retransmit received quantum particles back to the quantum interconnect transmitter 106 and the processing circuitry 212 associated with the quantum interconnect transmitter 106 may perform the step of comparing the physical observables of the received quantum particle with the position of the transmitted quantum particle. The processing circuitry 212 may calculate and record any differences in each of the degrees of freedom of a quantum particle. The processing circuitry 212, based on the frequency, number, and or strength of the measured discrepancies, may determine if an eavesdropper is performing strong or weak measurements and/or if the quantum interconnect link 102 is disturbed by some environment influence.

When transmitting quantum output data 216, the processing circuitry 212 may further determine the physical observables of the transmitted quantum particles and configure the quantum encoding device 214 to output quantum particles according to the determined state.

In some embodiments, the processing circuitry 212 includes a separate processor, specially configured field programmable gate array (FPGA), or a specially programmed application specific integrated circuit (ASIC).

In some embodiments, one or more of the sets of circuitry 208, 210, 212, 301, 302, 303, 304 are combinable. In some embodiments, one or more of the sets of circuitry perform some or all of the functionality described associated with another component. For example, in some embodiments, one or more sets of circuitry 208, 210, 212, 301, 302, 303, 304 are combined into a single module embodied in hardware, software, firmware, and/or a combination thereof. Similarly, one or more of the sets of circuitry, for example recording circuitry 208, digital conversion circuitry 210, and/or processing circuitry 212, is/are combined such that the processor 302 performs one or more of the operations described above with respect to each of these circuitry individually.

### Method for Probing Auxiliary Degrees of Freedom in a Quantum Communication System

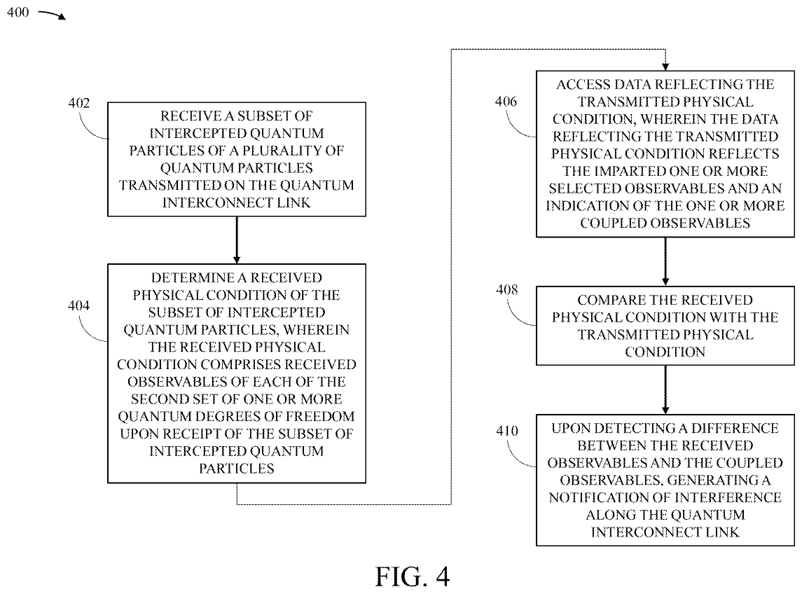

FIG. 4 illustrates a flowchart of an example process 400 for comparing a received quantum state to a transmitted quantum state in an auxiliary degree of freedom to detect interference on a quantum interconnect link 102. The operations illustrated in FIG. 4 may, for example, be performed by, with the assistance of, and/or under the control of a quantum device (quantum interconnect transmitter 106, quantum interconnect receiver 108, quantum interconnect eavesdropper 110), as described above. In this regard, performance of the operation may invoke one or more of processor 302, input/output circuitry 303, memory 301, communication interface 304, recording circuitry 208, digital conversion circuitry 210, and/or processing circuitry 212.

As shown in block 402, the method may include receiving a subset of quantum particles of a plurality of quantum particles transmitted on the quantum interconnect link 102. The received subset of quantum particles may be transmitted with a transmitted physical condition comprising one or more selected observables imparted to the subset of quantum particles within each of a first set of one or more quantum degrees of freedom. Further, each of the first set of one or more quantum degrees of freedom may be interconnected to a second set of one or more quantum degrees of freedom comprising one or more interconnected observables. In addition, each of the interconnected observables may be indirectly imparted by imparting the one or more selected observables to the subset of quantum particles. As described previously, a quantum interconnect transmitter 106 and a quantum interconnect receiver 108 may transmit data by encoding a value in the physical observables of a quantum particle (e.g., photon, electron, atom, etc.). The physical condition of a quantum particle is defined by all physical observables across a plurality of degrees of freedom. Due to the condition of the quantum interconnect link 102 and/or the presence of a third party (e.g., quantum interconnect eavesdropper 110) performing measurements on the transmitted quantum data 112, the physical condition as received at the quantum interconnect receiver 108 may be different than the physical condition of the quantum particle at the time of transmission at the quantum interconnect transmitter 106 (e.g., transmitted condition). In addition, degrees of freedom of a transmitted quantum particle may be interconnected such that manipulation of the particle within one degree of freedom inherently changes a characteristic of the particle in a second degree of freedom. For example, a modification to the spin of a quantum particle may cause a corresponding change in the spatial positioning of the quantum particle when in the presence of a Stern-Gerlach-like device. Thus, when generating quantum data 112, a quantum interconnect transmitter 106 may choose a degree of freedom to impart a specific physical characteristic representative of a value. However, the physical observables in an interconnected degree of freedom is also affected by imparting a physical characteristic to the first set of quantum degrees of freedom.

In some embodiments, a plurality of quantum particles may be transmitted on the quantum interconnect link 102 in the process of transmitting encoded data. A quantum interconnect receiver 108 may receive a quantum particle of the plurality of quantum particles by physically connecting to the quantum interconnect link 102 and/or by otherwise capturing the transmitted quantum data.

As shown in block 404, the method may further include determining a received physical condition of the subset of quantum particles, wherein the received physical condition comprises received observables of each of a second set of one or more quantum degrees of freedom, upon receipt of the subset of quantum particles. A quantum interconnect device may comprise optical components (e.g., probe 204) capable of performing measurements on the received subset of quantum particles in a plurality of degrees of freedom. As such, the quantum interconnect device may measure the received subset of quantum particles in the one or more degrees of freedom related to the encoded value to determine the encoded value. In addition, the quantum interconnect device may further measure physical observables in one or more degrees of freedom not directly associated with the encoded value. Physical observables across all degrees of freedom make up the overall physical condition of the subset of quantum particles. These physical observables may vary slightly from the transmitted physical observables even under ideal conditions (without an eavesdropper), but at least some of the physical observables may vary more substantially as a result of the presence of an eavesdropper performing measurements.

As shown in block 406, the method may further include accessing data reflecting the transmitted physical condition, wherein the data reflecting the transmitted physical condition reflects the imparted one or more selected observables and an indication of the one or more interconnected observables. Such data may specifically indicate the recorded physical observables at the time of transmission (e.g., polarization of the transmitted particle, spin of the transmitted particle, or other similar physical property). In some embodiments, this data may be provided by the processing circuitry (e.g., processing circuitry 212) based on the configuration parameters provided to the quantum encoding device 214. In some embodiments, a quantum interconnect receiver 108 may be provided access to data reflecting the transmitted observables of one or more transmitted quantum particles. In some embodiments, the quantum interconnect receiver 108 may be provided access to the data reflecting the transmitted observables of the transmitted quantum particles by transmission using the communication network 104, by accessing a common repository to which the quantum interconnect transmitter 106 may save observables of the transmitted quantum particles, or by a similar method. In some embodiments, the quantum interconnect receiver 108 may reflect or retransmit received quantum particles back to the quantum interconnect transmitter 106 and the quantum interconnect transmitter 106 may perform the comparison. In addition to the physical condition, including the one or more selected observables, the quantum interconnect receiver 108 may further access an indication of the interconnected observables associated with the imparted observables.

As shown in block 408, the method may further include comparing the received physical condition with the transmitted physical condition. With access to the transmitted physical condition, a quantum interconnect receiver 108 may, in some embodiments, compare the received physical condition of the transmitted quantum particle with the transmitted physical condition. The procedure for comparing may depend on the interconnected degree of freedom being compared. For example, in some embodiments, a quantum interconnect receiver 108 may compare the spatial location of a received quantum particle with the spatial location of the transmitted quantum particle and determine an overall displacement. For example, a quantum interconnect receiver 108 may determine an x,y location of a received quantum particle in the cross-section of the transmitting medium and determine the displacement as compared with the cross-sectional location of the transmitted quantum particle. A displacement in the spatial location may be an indication of a weak measurement performed, for example, using a Stern-Gerlach-like device to infer information about the spin of the quantum particle.

In some embodiments, a quantum interconnect receiver 108 may compare the time of arrival of a received quantum particle with a time of transmittal (e.g., the time a quantum particle was transmitted from the quantum interconnect transmitter 106) and determine a travel time of a quantum particle. In some embodiments, a quantum interconnect receiver 108 (or quantum interconnect transmitter 106) may compare the determined travel time with an expected travel time. A change in expected travel time may be an indication of an eavesdropping device intercepting the quantum particle or an anomaly on the quantum interconnect link 102.

In some embodiments, the quantum interconnect receiver 108 may measure the direction of spin, or the polarization angle and compare the received valued to the transmitted value.

As shown in block 410, the method may further include upon detecting a difference between the received observables and the interconnected observables, generating a notification of interference along the quantum interconnect link 102. Detecting a change in the interconnected observables between the time of transmission and the time of receipt at the quantum interconnect receiver 108 may be an indication that an interference has occurred on the quantum interconnect link 102, in some instances due to an eavesdropper, equipment misalignment, or a disturbance from the environment proximate the quantum interconnect link 102. In some embodiments, the quantum interconnect transmitter 106 and the quantum interconnect receiver 108 may establish an acceptable quantum bit error rate. A quantum bit error rate may represent the rate at which the received value matches the transmitted value when both the quantum interconnect transmitter 106 and the quantum interconnect receiver 108 both use the same basis. If the quantum bit error rate is exceeded and the quantum interconnect receiver 108 detects differences in the received and/or interconnected observables, a quantum interconnect receiver 108 may determine that a notification of interference may be sent to the quantum interconnect transmitter 106 and/or other quantum interconnect devices.

In addition, in some embodiments, the quantum interconnect receiver 108 and/or the quantum interconnect transmitter 106 may establish a maximum discrepancy, such that in an instance in which the maximum discrepancy for a particular degree of freedom is exceeded, a notification is generated. For example, if the auxiliary degree of freedom measured by the quantum interconnect receiver 108 is polarization. The quantum interconnect receiver 108 and/or the quantum interconnect transmitter 106 may establish that any disturbance over a certain threshold, for example 20 degrees, will be flagged. A total number of flagged transmissions or a number of flagged transmissions over a particular threshold may warrant generation of a notification of interference.

### System for Providing Feedforward Corrections in a Quantum Communication System

In reference to FIG. 5A, an example block diagram of a feedforward mechanism 500 for correcting the determination of quantum values is shown. As shown in FIG. 5A, the example feedforward mechanism 500 includes a quantum measurement device (e.g., device 506a) configured to perform a weak coupling between an input quantum particle 502a and a probe qubit 504a which could be represented by a different quantum particle or by a different degree of freedom of the same particle. In some embodiments, the probe qubit 504a may be generated to reflect the transmitted physical condition of the quantum particle 502a. In some embodiments, the probe qubit 504a may act as the quantum “needle” or “pointer” of an actual variable strength measurement device. The probe qubit 504a may be coupled to the physical observable of the input quantum particle 502a to be measured, however, the probe qubit 504a may minimally alter the physical observables on the encoding degree of freedom. Based on the weak coupling, the device 506a may generate a feedforward correction measurement 508a based on the difference between the input quantum particle 502a and the probe qubit 504a. The measured difference between the two particles, thus represents the change to the transmitted quantum particle due to noise or other disturbances on the quantum interconnect link 102. The feedforward correction measurement 508a may then be applied to the future input quantum particles 502a by the feedforward correction device 510a. Thus, producing an output quantum particle 512a in which the physical condition has been corrected to compensate for noise or other disturbances on the quantum interconnect link 102.

In reference to FIG. 5B, an example quantum interconnect network 100b is provided illustrating the use of a feedforward correction in a quantum interconnect network 100b. As shown in FIG. 5B, the example quantum interconnect network 100b includes a plurality of quantum interconnect devices 506b, and an input quantum particle 502b transmitted between various quantum interconnect devices 506b on the quantum interconnect network 100b. As described in relation to FIG. 5A, the quantum interconnect device 506b may receive an input quantum particle 502b and a generated probe qubit 504b based on the transmitted physical condition of the quantum particle 502b. Utilizing a weak coupling between the input quantum particle 502b and the probe qubit the quantum interconnect device 506b may generate a feedforward correction measurement 508b based on the difference between the input quantum particle 502b and the generated probe qubit 506b. Once again, the feedforward correction measurement 508b may be used by the feedforward correction device 510b to correct future input quantum particles 502b, thus producing an output quantum particle 512b in which the physical condition has been corrected to compensate for noise or other disturbances on the quantum interconnect link 102.

Many modifications and other embodiments will come to mind to one skilled in the art to which this disclosure pertains having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for communicating on a quantum interconnect link, the method comprising:
receiving a subset of quantum particles of a plurality of quantum particles transmitted on the quantum interconnect link,
wherein the subset of quantum particles is transmitted having a transmitted physical condition comprising one or more selected physical observables imparted to the subset of quantum particles within each of a first set of one or more quantum degrees of freedom,
wherein each of the first set of one or more quantum degrees of freedom are coupled to a second set of one or more quantum degrees of freedom comprising one or more coupled observables, and
wherein each of the coupled observables are indirectly imparted by imparting the one or more selected observables to the subset of quantum particles;
determining a received physical condition of the subset of quantum particles, wherein the received physical condition comprises received observables of each of the second set of one or more quantum degrees of freedom upon receipt of the subset of quantum particles;
accessing data reflecting the transmitted physical condition, wherein the data reflecting the transmitted physical condition reflects the imparted one or more selected observables and an indication of the one or more coupled observables;
comparing the received physical condition with the transmitted physical condition; and
upon detecting a difference between the received observables and the coupled observables, generating a notification of interference along the quantum interconnect link.

2. The method of claim 1, wherein a value representing one or more qudits is encoded by imparting the selected observables to the subset of quantum particles.

3. The method of claim 1, wherein determining a received physical condition comprises:
identifying a second set of one or more quantum degrees of freedom; and
determining one or more coupled observables for each of the second set of one or more quantum degrees of freedom.

4. The method of claim 1, wherein the quantum degrees of freedom include one or more of:
polarization, time-of-arrival, spatial displacement, relative phase, orbital angular momentum, spatial modes, energy/frequency, quantized quadratures and/or spin.

5. The method of claim 1, wherein the transmitted physical condition is received on a secondary communication channel separate from the quantum interconnect link.

6. The method of claim 1, wherein the notification of interference indicates detection of an eavesdropper accessing the quantum interconnect link.

7. The method of claim 1, wherein the subset of quantum particles are transmitted by a transmitting device and the method further comprises, upon detecting a difference between the received observables and the coupled observables, transmitting data reflecting the detected difference to the transmitting device to cause the transmitting device to adjust one or more transmission parameters to compensate for anomalies in the quantum interconnect link.

8. The method of claim 1, further comprising:
upon detecting a difference between the received observables and the coupled observables, remediating at least one irregularity on the quantum interconnect link to obscure an eavesdropper's ability to identify an encoded valued transmitted via the quantum interconnect link.

9. An apparatus for communicating on a quantum interconnect link, the apparatus comprising:
a probe coupled with the quantum interconnect link,
wherein the probe is configured to receive a subset of quantum particles of a plurality of quantum particles transmitted on the quantum interconnect link,
wherein the probe is configured to measure one or more selected observables imparted to the subset of quantum particles within each of a first set of one or more quantum degrees of freedom, and
wherein the probe is configured to measure one or more coupled observables defined for each of a second set of one or more quantum degrees of freedom, wherein each of the coupled observables is indirectly imparted by imparting the one or more selected observables to the subset of quantum particles;
communication circuitry configured to access a transmitted physical condition, wherein data reflecting the transmitted physical condition reflects the imparted one or more selected observables and an indication of the one or more coupled observables, and
processing circuitry configured to:
determine a received physical condition of the subset of quantum particles, wherein the received physical condition has received observables defined for each of the second set of one or more quantum degrees of freedom;
compare the received physical condition with the transmitted physical condition; and
upon detecting a difference between the received observables and the coupled observables, generate a notification of interference along the quantum interconnect link.

10. The apparatus of claim 9, wherein a value representing one or more qudits is encoded by imparting the selected observables to the subset of quantum particles.

11. The apparatus of claim 9, wherein determining a received physical condition comprises:
identifying a second set of one or more quantum degrees of freedom; and
determining one or more coupled observables for each of the second set of one or more quantum degrees of freedom.

12. The apparatus of claim 9, wherein the quantum degrees of freedom include one or more of: polarization, time-of-arrival, spatial displacement, relative phase, orbital angular momentum, spatial modes, energy/frequency, quantized quadratures and/or spin.

13. The apparatus of claim 9, wherein the transmitted physical condition is accessed on a secondary communication channel separate from the quantum interconnect link.

14. The apparatus of claim 9, wherein the notification of interference indicates detection of an eavesdropper accessing the quantum interconnect link.

15. The apparatus of claim 9, wherein the subset of quantum particles is transmitted by a transmitting device and the method further comprises, upon detecting a difference between the received observables and the coupled observables, transmitting data reflecting the detected difference to the transmitting device to cause the transmitting device to adjust one or more transmission parameters to compensate for anomalies in the quantum interconnect link.

16. A computer program product for communicating on a quantum interconnect link, the computer program product comprising at least one non-transitory computer-readable storage medium storing program instructions that, when executed, cause the computer program product to:
receive a subset of quantum particles of a plurality of quantum particles transmitted on the quantum interconnect link,
wherein the subset of quantum particles is transmitted having a transmitted physical condition comprising one or more selected physical observables imparted to the subset of quantum particles within each of a first set of one or more quantum degrees of freedom,
wherein each of the first set of one or more quantum degrees of freedom are interconnected to a second set of one or more quantum degrees of freedom comprised of one or more interconnected observables, and
wherein each of the coupled observables are indirectly imparted by imparting the one or more selected observables to the subset of quantum particles;
determine a received physical condition of the subset of quantum particles, wherein the received physical condition comprises received observables of each of the second set of one or more subset of quantum particles upon receipt of the subset of quantum particles,
access data reflecting the transmitted physical condition, wherein the data reflecting the transmitted physical condition reflects the imparted one or more selected observables and an indication of the one or more coupled observables;
compare the received physical condition with the transmitted physical condition; and
upon detecting a difference between the received observables and the coupled observables, generating a notification of interference along the quantum interconnect link.

17. The computer program product of claim 16, wherein a value representing one or more qudits is encoded by imparting the selected observables to the subset of quantum particles.

18. The computer program product of claim 16, wherein determining a received physical condition comprises:
identifying a second set of one or more quantum degrees of freedom; and
determining one or more interconnected observables for each of the second set of one or more quantum degrees of freedom of the quantum particle.

19. The computer program product of claim 16, wherein the quantum degrees of freedom include one or more of: polarization, time-of-arrival, spatial displacement, relative phase, orbital angular momentum, spatial modes, energy/frequency, quantized quadratures and/or spin.

20. The computer program product of claim 16, wherein the transmitted physical condition is received on a secondary communication channel separate from the quantum interconnect link.

21. The computer program product of claim 16, wherein the notification of interference indicates detection of an eavesdropper accessing the quantum interconnect link.

22. The computer program product of claim 16, wherein the subset of quantum particles is transmitted by a transmitting device and the method further comprises, upon detecting a difference between the received observables and the coupled observables, transmitting data reflecting the detected difference to the transmitting device to cause the transmitting device to adjust one or more transmission parameters to compensate for anomalies in the quantum interconnect link.
